(19) United States
(12) Patent Application Publication
(10) Pub. No.: US 2008/0308466 A1
(43) Pub. Date: Dec. 18, 2008

(54) Mineral Recovery from Ore

(76) Inventor: Barry Graham Lumsden, New South Wales (AU)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/094,329

(22) PCT Filed: Nov. 21, 2006
(86) PCT No.: PCT/AU06/01739

§ 371 Date: May 20, 2008

(30) Foreign Application Priority Data
Nov. 22, 2005 (AU) 2005906487

(51) Int. Cl. B03D 1/14

(52) U.S. Cl. 209/164; 209/166

(57) ABSTRACT

A metal or mineral compound collector for use in a froth flotation process so as to recover one or more desired minerals or metals; the collector comprising a functional group attached to a carbon chain; the functional group being a nitrile and the said chain having (11) or more carbon atoms. In a further form there is provided a method of recovering a metal or mineral compound from an ore comprising the steps of: wet grinding the ore to a desired particle size; adding water chemicals such as frothers or slurry-modifiers to the ground ore so as to prepare a slurry; adding an effective proportion of a collector comprising a functional group which has a carbon chain with a nitrile attached, said chain having (11) or more carbon atoms; supplying a gas stream to the slurry so as to generate a froth; and recovering the desired metal, mineral and/or sulphide thereof in the froth.

### FIELD OF INVENTION

The present invention relates to a substance, method and process for recovering minerals and precious metals from metal ores by froth flotation, and more particularly although not necessarily exclusively, relates to a method of improving the efficiency of recovery of sulphide minerals and precious metals from ores utilising a collector in the froth flotation process.

### BACKGROUND OF INVENTION

Froth flotation is a commonly used method for recovering valuable minerals from ores. In fact it is the primary method for recovering the sulphides of copper, lead and zinc from ore. Some sulphide ores also contain the precious metals gold, silver and platinum group metals which may also be recovered by froth flotation.

In the froth flotation of sulphide ores, the ore is generally wet ground to a desired particle size. While this size may vary depending on the ore, typically it is where 80% of the particles are less than 100 um. To this ground ore slurry, chemicals are added. The chemicals that can be added may be pH or other slurry modifiers, collectors that collect the desired mineral, frothers that cause a froth in the cell, and depressants that depress the flotation of the waste minerals in the ore. The ore slurry with chemicals added passes to a separation tank, usually called a flotation cell and air is bubbled through the separation tank and the desired minerals that have the collector attached attach to a bubble and enter the froth phase, called the concentrate. The undesired minerals remain in the slurry, usually termed the tailings and so there is a separation. There is not of course complete separation, some of the valuable mineral does remain in the slurry and report to the tailings while some of the undesired minerals enter the concentrate diluting the desired minerals.

Collectors are chemicals that facilitate the selective separation in the process. The collector attaches to the desired mineral imparting a hydrophobicity to the mineral/collector complex. This hydrophobicity ensures that the mineral/collector complex prefers to attach to the air bubble rather than remain in the slurry because it is hydrophobic. Choosing the best collector for the ore is important in maximising the separation. A collector that does not attach very well to the desired mineral, or that attaches too well to the undesired mineral will make the separation less efficient. For instance in a copper processing operation only perhaps 90-95% of the copper is recovered in the froth phase by flotation and the concentrate may only be 80-95% pure. For a medium sized operation the losses might be 5000 t/yr of copper which at today's prices would be worth USD35 million per year.

An improved collector, one that increases the selective recovery of the desired sulphide mineral or that selectively reduces the recovery of undesired mineral would be greatly beneficial to the mineral processing industry and also to the availability of metals to the world community.

Because of the chemical interaction between collectors and the mineral surfaces collectors are generally mineral type specific. This maximizes the separation efficiency by flotation. So for instance xanthates and dithiophosphates are sulfide mineral collectors, diesel or other hydrocarbons are coal collectors and fatty acids are oxide mineral collectors. There is not usually an overlap between minerals and collectors. Diesel or other similar hydrocarbons are generally detrimental to sulfide flotation

Collectors are made up of a functional group that attaches to the valuable mineral and a hydrophobic tail, usually a hydrocarbon chain, that attaches to the bubble. There are a range of chemicals that are used as collectors. Most of the currently used collectors have been in use for many decades. For sulfides generally the functional group is a sulphur containing group, and the hydrophobic tail is a hydrocarbon chain. Some examples of the classes of these collectors are: xanthates, dithiophosphates, thionocarbamates, mercaptobenzylthiazoles, monothiophosphates and dithiophosphinates. These classes describe the functional groups that are thought to attach to the sulphide particle. Generally the functional groups characterise a collector. So xanthates are known as being non-selective strong collectors, whereas dithiophosphates are considered more selective and good precious metal collectors. The hydrophobic hydrocarbon tail is also important. These hydrocarbon tails are generally always short chain carbon chains, of C1-C5. For example in the dithiophosphate class: diethyl dithiophosphate to diisobutyldithiophosphate are the most widely used. In the xanthate class: ethylxanthate to amylxanthate are the most widely used. There are also some collectors where the hydrophobic chain may be a benzyl ring of 6 carbons.

While the functional groups are important in the selective flotation recovery of a class of mineral the hydrophobic hydrocarbon tail is also critical to the collector's performance and optimizing the mineral separation. So for instance not only xanthate or dithiophosphate with one hydrocarbon tail is optimum for all separations, but rather a range of xanthates or dithiophosphates with different hydrocarbon chain tails are used. Generally the longer the hydrophobic hydrocarbon tail the less selective the collector becomes. If the hydrocarbon tail is too long then the collector is unselective and will recover a lot of waste material in the concentrate. Also if the hydrophobic hydrocarbon tail is too long then the collector tends to be insoluble in water, and so it is more difficult for the collector to attach to mineral particles. Because these collectors are in effect surfactants (surface active agents or detergents) if the hydrophobic tail is too long then they tend to be very frothy and may create problems in the plant operation.

The fact that the longer the hydrocarbon tail the less selective the collector is widely understood in the literature. By less selective it is meant that instead of recovering just the valuable sulphide mineral, many undesired minerals are also recovered. In sulphide flotation the desired sulphide is generally a sulphide of copper, zinc or lead and the undesired mineral is a sulphide of iron or a gangue mineral. The maximum length of the hydrocarbon used in industry is generally five. This applies to the two most commonly used sulphide collectors xanthates and dithiophosphates. So, Cytec (previously American Cyanamid) a major supplier of collectors states that ethyl xanthate (2 carbons) is used “where maximum selectivity is desired”, whereas amyl xanthate (5 carbons) is “the most powerful and least selective xanathate” (Page 63 American Cyanamid Mining Chemical Handbook 1989). The same is said of dithiophosphates, with the diethyl dithiophosphate being described as “very selective against iron sulfides” whereas the methyl amyl dithiophosphate is described as “a strong copper collector” (Page 65 American Cyanamid Mining Chemical Handbook 1989). More particularly the lower selectivity of long chain sulfide collectors has been well detailed in the literature. (See Ackerman, P. Harris, G. Klimpel, R and Aplan, F., “Evaluation of Flotation Collectors for Copper Sulfides and Pyrite, III. Effect of Xanthate Chain Length and Branching”, International Journal of Mineral Processing, 21 (1987) 141-156). The paper starts with the sentences “Historically, it has been thought that the longer the alkyl chain length of a xanthate, the stronger the flotation of a sulphide mineral. However, due to a diversity of factors, increasing the alkyl chain length actually can cause a decrease in flotation for certain minerals while increasing the flotation of others.” The paper details experiments that show that using a xanthate with more than 5 carbons does not increase the recovery of the desired copper sulphide minerals, and in fact as the carbon chain length increases above 5 there is a decrease in recovery for some copper minerals. However, as the chain length increases there is a significant increase in the recovery of the undesired mineral pyrite (iron sulphide). That is, selectivity decreases. Ackerman et al's testwork shows that while the carbon chain length is 5 or less the increase in pyrite recovery is offset by the increase in copper recovery, but when the carbon chain length is greater than 5 there is no increase in copper recovery (or even a decrease) and an increase in pyrite recovery. Therefore, increasing the carbon chain length above 5 for xanthates is detrimental to the selective flotation of copper sulfides from ore. This is the commercial and industrial situation where the sulfide collectors used by industry are almost always have a carbon chain 5 carbons or less. These experimental results are graphed in the graphs shown in FIGS. 1 and 2.

Carbon when bonded to nitrogen via a triple bond is known as a nitrile or cyanide group. Cyanide is used as a flotation modifier and is a well known depressant in sulphide flotation. At dose rates in the region of 5-250 g/T cyanide is known to depress copper sulphides, zinc sulphides, nickel sulphides and iron sulphides in flotation. It is also known to depress the flotation of gold and silver. Cyanide then can be used in flotation separation processes when two sulphides are being separated because it depresses the metal sulphides at different rates. For example cyanide can be used to depress zinc sulphide when lead sulphide is being recovered or to depress iron sulfide when copper sulfide is being recovered.

Cyanide is also the preferred leaching agent in the recovery of gold and silver by leaching. Cyanide dissolves gold and silver particles very efficiently. Organic nitrites have also been found to be efficient at leaching gold.

Organic nitriles are organic molecules where a nitrile (cyanide) is attached to the carbon chain. The organic chain to which the nitrile group is attached can be saturated (all single C—C bonds) or unsaturated (some double or triple C—C bonds). The nitrile group may be attached to the first carbon in the chain (primary nitrite) or another carbon in the chain (secondary nitrile).

Organic nitrites have been evaluated in the past as sulphide collectors (U.S. Pat. No. 2,166,093) covers the use of short chain nitrites as collectors for sulphides. However, this patent specifically limits the carbon chain length to 3 to 10 carbons, and the carbon chain is either saturated or unsaturated. The limit of carbon chain length of the organic nitrites discussed in this patent is consistent with the industry practice of using short carbon chain collectors. Moreover, the patent describes using the nitrile mixtures at concentrations of over 150 ppm (parts per million or mg/litre). The patent also teaches that these nitrites will specifically separate sulphides from silicious gangue.

U.S. Pat. No. 2,175,093 teaches that dinitriles (CN(C₂)ₙCN) that have a nitrile group at both ends of the carbon chain and where there are at least 4 carbons are effective collectors These dinitriles at dosages of around 50-100 g/t are superior collectors to xanthates.

While U.S. Pat. No. 2,166,093 teaches that nitrites with 3-10 carbons will selectively separate sulphides from silicious minerals, U.S. Pat. No. 2,298,281 teaches that a primary amine/nitrile mixture will selectively float silicious minerals U.S. Pat. No. 2,298,281 is inconsistent with U.S. Pat. No. 2,166,093 that teaches that silicious mineral is not floated well by nitrites. The primary amine in combination with the nitrile is better than the amine alone. This patent emphasises the need for a mixture of primary amine and nitrile for recovering silicious mineral. Generally the nitrile is above 20% of the mixture and generally less than 50%. It should be noted that primary amines are currently used commercially as silicious mineral collectors, but not commercially as sulphide collectors.

There are a number of patents where the patentees have modified generally used flotation collectors by the addition of a nitrile group to the carbon chain. The nitrile group like the chlorine, bromine or nitro group is known to be an electronegative group and so can affect the functional groups ability to attach to a mineral. These patents are not teaching that the nitrile group is the functional group that attaches to the mineral rather that they modify the functional mineral attaching group. So U.S. Pat. No. 3,301,400 modifies a xanthate to a cyanovinyl xanthate, U.S. Pat. No. 3,298,520 modifies a dithiocarbamate to a cyanovinyl dithiocarbamate, U.S. Pat. No. 3,353,671 modifies xanthate esters with the addition of a nitrile group to the carbon chains U.S. Pat. No. 4,556,483 gives the option of modifying a hydroxycarboxycarbonyl thiourea by the addition of a nitrile group to the carbon chain.

Long chain cyanides (nitrites) have been used as an additive in the flotation of coal (U.S. Pat. No. 4,678,561), a completely different mineral class to sulphides. In this application the nitrile is not the collector but an additive, for the nitrile to work efficiently the nitrile must be soluble in the collector or the frother. Coal flotation is very different to sulphide flotation and the collectors in coal flotation are in no way similar to sulphide collectors. This patent specifically states that the nitrites depress (reduce the recovery) of sulphides (in this case iron sulphides), and that is a benefit of the nitrites.

Coal is a mineral that can be separated from the non-coal waste by flotation. Coal flotation is quite different to sulphide flotation. Coal is naturally hydrophobic and normal practise is the use of a hydrocarbon collector like diesel and a frother. The hydrocarbon collector has no specific functional groups as does a sulphide mineral collector. Also in the flotation of coal the sulphides like pyrite are being rejected and report to the tailings. Coal flotation is not then the flotation of sulphides but the rejection of sulphides. U.S. Pat. No. 4,678,561 teaches that nitrites in conjunction with hydrocarbon collectors can improve the coal flotation. In this patent the hydrocarbon is the collector and the nitrile is used at only around 10% of the dosage of the hydrocarbon collector. The nitrile improves the rejection of sulphides and improves the recovery of coal. Of particular note is that the nitrile needs to be soluble in the hydrocarbon collector or frother.

The teaching of the literature (Ackerman et al) that the sulfide collector xanthate with more than 5 carbons in the hydrophobic chain are worse collectors for selective flotation, and widespread industry usage of short chain (C₂-C₅) sulfide collectors with and U.S. Pat. No. 2,166,093 that short nitrites are efficient collectors it is surprising that long chain nitrites with carbon chains of 12-20 carbons are very selective collectors for sulfide minerals.

It is an object of the present invention to address or ameliorate some of the above disadvantages or to at least offer a useful alternative.

### Notes

1. The term “comprising” (and grammatical variations thereof) is used in this specification in the inclusive sense of “having” or “including”, and not in the exclusive sense of “consisting only of”.
2. The above discussion of the prior art in the Background of Invention, is not an admission that any information discussed therein is citable prior art or part of the common general knowledge of persons skilled in the art in any country.

### SUMMARY OF INVENTION

### Definitions:

1. Aliphatic—an adjective to describe organic compounds in which carbon atoms are joined together in straight or branched chains as opposed to aromatic compounds which include a benzene ring; aliphatics include not only the fatty acids and other derivatives of paraffin hydrocarbons but also unsaturated compounds, such as ethylene and acetylene.
2. Nitrile—an organic compound which has a —CαN functional group. In the —CN group, the carbon atom and the nitrogen atom are triple bonded together. The —CN group is also, although less properly, referred to as a cyanide group or cyano group and compounds with them are sometimes referred to as cyanides. The words ‘nitrile’ and ‘cyanide’ at least in the context of this specification are interchangeable
3. Metal Collector—a collector which collect pure metals or elements such as gold, silver or platium.
4. Mineral Collector—a collector which collect compounds, especially metallic sulphides.
5. Collector refers to either a metal collector as defined above or a mineral collector as defined above.

Accordingly, in one broad form of the invention there is provided a metal or mineral compound collector for use in a froth flotation process so as to recover one or more desired minerals or metals; the collector comprising a functional group attached to a carbon chain; the functional group being a nitrile and the said chain having 11 or more carbon atoms.

In a further broad form of the invention there is provided a method of recovering a metal or mineral compound from an ore comprising the steps of:
wet grinding the ore to a desired particle size;
adding water chemicals such as frothers or slurry modifiers to the ground ore so as to prepare a slurry;
adding an effective proportion of a collector comprising a functional group which has a carbon chain with a nitrile attached, said chain having 11 or more carbon atoms;
supplying a gas stream to the slurry so as to generate a froth; and
recovering the desired metal, mineral and/or sulphide thereof in the froth.

Preferably, the collector comprises a mixture of nitriles in which one or more predominating nitrites contain at least 11 carbon atoms.

Preferably, the collector comprises a mixture of nitrites in which one or more predominating nitrites contain at least 12 carbon atoms.

Preferably, the collector comprises a mixture of nitrites in which one or more predominating nitrites contain at least 13 carbon atoms.

Preferably, the collector comprises a mixture of nitrites in which one or more predominating nitrites contain at least 14 carbon atoms.

Preferably, the collector comprises a mixture of nitrites in which one or more predominating nitriles contain at least 15 carbon atoms.

Preferably, the collector comprises a mixture of nitrites in which one or more predominating nitrites contain at least 16 carbon atoms.

Preferably, the collector comprises a mixture of nitrites in which one or more predominating nitriles contain at least 17 carbon atoms.

Preferably, the collector comprises a mixture of nitriles in which one or more predominating nitriles contain at least 18 carbon atoms.

Preferably, the collector comprises a mixture of nitriles in which one or more predominating nitrites contain between 11 to 20 carbon atoms.

Preferably, the collector comprises a mixture of nitriles in which one or more predominating nitrites contain between 12 to 20 carbon atoms.

Preferably the collector comprises a mixture of nitriles in which one or more predominating nitrites contain between 13 to 20 carbon atoms.

Preferably, the collector comprises a mixture of nitriles in which one or more predominating nitriles contain between 14 to 20 carbon atoms.

Preferably, the collector comprises a mixture of nitrites in which one or more predominating nitrites contain between 15 to 20 carbon atoms.

Preferably, the collector comprises a mixture of nitrites in which one or more predominating nitrites contain between 16 to 20 carbon atoms.

Preferably, the collector comprises a mixture of nitriles in which one or more predominating nitriles contain between 17 to 20 carbon atoms.

Preferably the collector comprises a mixture of nitriles in which one or more predominating nitrites contain at least 18 to 20 carbon atoms.

Preferably the collector comprises one carbon chain length.

Preferably said collector includes a dodecyl nitrile.

Preferably said collector comprises a mixture of nitriles having different carbon chain lengths.

Preferably said collector includes a coco nitrile or hydrogenated tallow nitrile.

Preferably the mineral compound includes metallic sulphides.

Preferably the mineral compound comprises metallic sulphides including chalcopyrite, bornite, chalcocite, covellite, galena, sphalerite thereof

Preferably the metals include gold, silver or platinum group metals.

Preferably said chain is saturated.

Preferably the functional group includes a mixture of two or more nitriles.

Preferably one of the nitrites is a secondary nitrile.

Preferably the collector is mixed with xanthates, dithiophosphates or other sulphide collectors.

Preferably one or more of the carbons in the carbon chain is substitutable.

Preferably the carbon chain is substitutable by other chemical groups including alkyl, benzyl, chlorine, bromine, alkoxy, nitro or nitrile.

### BRIEF DESCRIPTION OF DRAWINGS

Embodiments of the present invention will now be described with reference to the accompanying drawings wherein:

FIG. 1 is a graph illustrating the relationship between the number of carbons in a prior art collector and the recovery efficiency of Chalcopyrite, Chalcocite and Pyrite. The collector dosage is 1×10⁻⁶ M.

FIG. 2 is a graph illustrating the relationship between the number of carbons in a prior art collector and the recovery efficiency of Covellite and Pyrite. The collector dosage is 1×10⁻⁵ M.

FIG. 3 is a symbolic diagram showing a flotation cell within which a method of recovering metal or mineral compound in accordance with the present invention may be carried out.

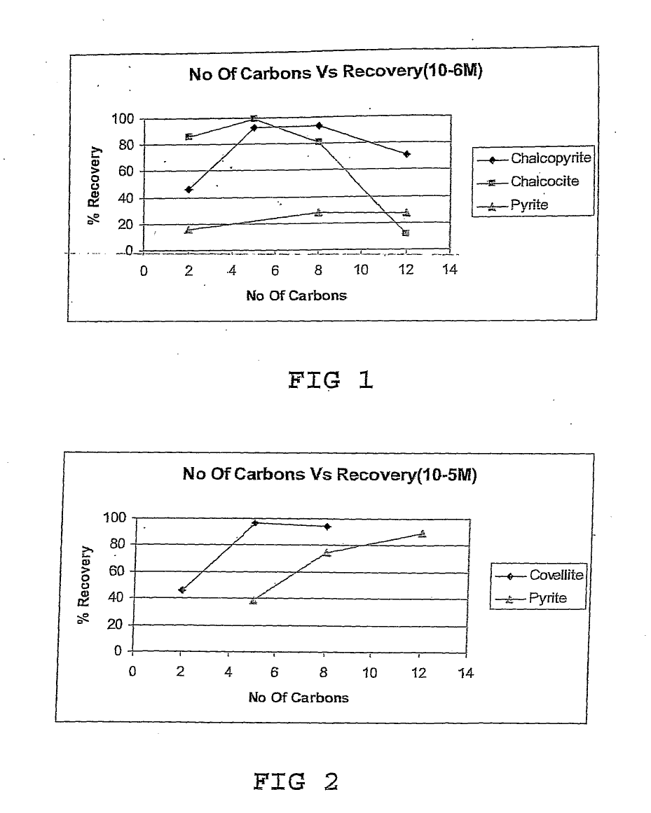

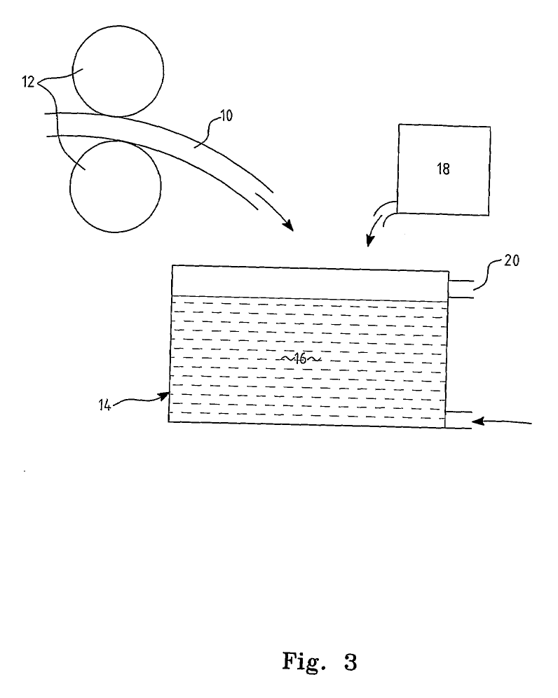

### DETAILED DESCRIPTION OF PREFERRED EMBODIMENTS

The nitrile collectors in a preferred embodiment of the present invention have more than 10 carbon atoms and a single nitrile group. Long chain (C>10) nitrites improve the recovery of sulphides and precious metals in froth flotation. Longer carbon chains are much better and may work at levels as low as 5 mg/liter. Even though they serve the purpose, dinitriles are not as good as nitrites. Similarly, tests with aromatic nitrites have been shown to provide reasonable separation behaviour although not as good as with aliphatic nitrites.

Surprisingly it has been shown that organic nitriles with long hydrophobic hydrocarbon (11-20 or more carbons) tails are efficient collectors for sulphide flotation. These results are surprising for three reasons. Firstly, they have hydrocarbon tails two to ten times the length of typical sulphide flotation collectors. Long hydrophobic carbon tails are understood to be non-selective (Cytec and Ackerman et al). They are collectors that are insoluble in water and they tend to make the collectors very frothy. Secondly, the functional group does not contain a sulfur atom which is not usual for sulfide collectors. The nitrile functional group is identified as a depressant for sulphides in flotation.

The usual dosage of these collectors is generally in the range 10 g/t to 100 g/t. The nitrile collectors may be pure, having only one carbon chain length, such as dodecyl nitrile, or they may be mixtures of a range of carbon chain lengths such as coco nitrile or tallow nitrile. The nitrile collector may be all saturated carbon chains or they may have a component that is unsaturated but saturated seems to be better. The hydrocarbon chain for the nitrile collector may be substituted with other groups such as alkyl, benzyl, chlorine, bromine, alkoxy, nitro, nitrile or it may be only hydrogens. The nitrile collector may be used alone as the only collector or it may be used in combination with other sulphide collectors such as dithiophosphate or xanthate or thionocarbamates.

The sulphide minerals to be recovered could be copper sulphides like chalcopyrite, bornite or chalcocite, zinc sulphides, lead sulphides, nickel sulphides, arsenosulphides or iron sulphides. The precious metals could be silver, gold and platinum group metals.

### EXAMPLE 1

A copper sulphide ore was ground to 80% passing 100 um and tested in a Denver Laboratory Flotation Cell. Frother was added at 10 g/t and collector at 15 g/t. Conditioning time was 2 minutes and flotation time was 7 minutes. The copper in the feed averaged 5%.

| | % Cu | % Cu Grade in |
|---|---|---|
| Collector | Recovery | Concentrate |
| Butyl nitrile | 56.8 | 22.2 |
| Hexyl nitrile | 74.0 | 24.3 |
| Hexyl dinitrile | 58.0 | 22.4 |
| Alkyl alkyl | 84.3 | 23.7 |
| thionocarbamate | | |

The longer the carbon chain the better the copper recovery, and a single nitrite is better than a dinitrile, but not as good as a typical copper collector in dialkyl thionocarbamate.

### Example 2

A copper sulphide ore was ground to 80% passing 100 um and tested in a Denver Laboratory Flotation Cell. Frother was added at 10 g/t and collector at 15 g/t. Conditioning time was 2 minutes and flotation time was 7 minutes. The copper in the feed averaged 3.1%.

| | % Cu | % Cu Grade in |
|---|---|---|
| Collector | Recovery | Concentrate |
| Dodecyl nitrile | 98.4 | 20.2 |
| Decyl nitrile | 97.9 | 16.3 |
| Alkyl alkyl | 97.3 | 17.5 |
| thionocarbamate | | |

Dodecyl nitrile was better than the decyl nitrile and better than the typical sulphide collector alkyl alkyl thionocarbamate.

### Example 3

A copper sulphide ore was ground to 80% passing 100 um and tested in a Denver Laboratory Flotation Cell. Frother was added at 10 g/t and collector at 15 g/t. Conditioning time was 2 minutes and flotation time was 7 minutes. The copper in the feed averaged 5.5%.

| | % Cu | % Cu Grade in |
|---|---|---|
| Collector | Recovery | Concentrate |
| Dodecyl nitrile | 94.8 | 21.9 |
| Dodecyl | 96.2 | 19.8 |
| nitrile/diisobutyldi- | | |
| thiophosphatel:1 | | |
| blend | | |
| Hexadecyl | 95.7 | 20.0 |
| nitrile/diisobutyldi- | | |
| thiophosphatel:1 | | |
| blend | | |
| Alkyl alkyl | 93.9 | 20.6 |
| thionocarbamate | | |

The performance of the dodecyl nitrile was improved by the addition of some diisobutyldithiophosphate.

### Example 4

A copper sulphide ore was ground to 80% passing 90 um and tested in a Denver Laboratory Flotation Cell. Frother was added at 25 g/t and collector at 16 g/t. Conditioning time was 6 minutes and flotation time was 14 minutes. The copper in the feed averaged 0.9%.

| | % Cu |
|---|---|
| Collector | Recovery |
| Dodecyl nitrile | 89.1 |
| Octyl nitrile | 88.9 |
| Hexyl nitrile | 87.4 |
| Dodecyl nitrile/Amyl | 93.8 |
| Xathate | |

A dodecyl nitrile/xanthate blend is better than dodecyl nitrile alone and dodecyl nitrile is better than the shorter chain octyl nitrile or the hexyl nitrile.

### Example 5

A copper sulphide/gold ore was ground to 80% passing 90 um and tested in a Denver Laboratory Flotation Cell. Frother was added at 25 g/t and collector at 16 g/t. Conditioning time was 6 minutes and flotation time was 14 minutes. The copper in the feed averaged 0.87% Cu and 0.35 ppm Au.

| | % Cu | % Cu Grade in | % Au |
|---|---|---|---|
| Collector | Recovery | Concentrate | Recovery |
| Dodecyl nitrile/Amyl | 94.2 | 7.8 | 71.7 |
| Xanthate | | | |
| Alkyl alkyl | 94.2 | 7.8 | 69.7 |
| thionocarbamate/Amyl | | | |
| Xanthate | | | |

### Example 6

A copper sulphide/gold ore was ground to 80% passing 65 um and tested in a Denver Laboratory Flotation Cell. Frother was added at 20 g/t and collector at 32 g/t. Conditioning time was 6 minutes and flotation time was 4 minutes. The copper in the feed averaged 0.31% Cu and 3.1 ppm Au.

| | % Cu | % Cu Grade in | % Au |
|---|---|---|---|
| Collector | Recovery | Concentrate | Recovery |
| Dodecyl nitrile/Di- | 63.5 | 6.5 | 28.6 |
| isobutyl | | | |
| dithiophosphate | | | |
| Alkyl alkyl | 53.7 | 6.7 | 21.2 |
| thionocarbamate/Di- | | | |
| isobutyl | | | |
| dithiophosphate | | | |

In combination with dithiophosphate the nitrile is better than the thionocarbamate.

### Example 7

A copper sulphide/gold ore was ground to 80% passing 90 um and tested in a Denver Laboratory Flotation Cell. Frother was added at 25 g/t and collector at 16 g/t. Conditioning time was 6 minutes and flotation time was 14 minutes. The copper in the feed averaged 0.87% Cu and 0.35 ppm Au.

| | % Cu | % Cu Grade in | % Au |
|---|---|---|---|
| Collector | Recovery | Concentrate | Recovery |
| Tallow nitrile | 93.8 | 6.1 | 73.0 |
| Hydrogenated tallow | 94.7 | 6.5 | 75.0 |
| nitrile | | | |

The saturated nitride (hydrogenated tallow nitrite) gives a better performance than the tallow nitrile a mixed saturated and unsaturated nitrite.

### Effect of Increasing Carbon Chain Length

Experimental results to date indicate, surprisingly, that the longer the carbon chain the more efficient the separation process may be. Experiments were conducted utilizing coconitrile which includes primarily a mix of nitrites of carbon chain length 12, 14 and 16. The results are as indicated in the table below:

| | % Cu | % Au |
|---|---|---|
| | Recovery | Recovery |
| Coconitrile | 94.7 | 75.6 |
| Alkyl, alkyl | 94.1 | 72.2 |
| thionocarbamate | | |

Experiments were also conducted using hydrogenated tallow nitrile which comprises primarily saturated nitrites of carbon chain length 16 and 18 with the separation results as indicated in the following table:

| | % Cu | % Au |
|---|---|---|
| | Recovery | Recovery |
| Hydrogenated | 95.4 | 76.0 |
| Tallow Nitrile | | |
| Alkyl, alkyl | 94.6 | 72.7 |
| thionocarbamate | | |

Broadly, it can be seen that separation efficiency trends upwards as the carbon chain length increases beyond C10.

Location of Carbon Chain

The majority of experimental results as given elsewhere in this specification exemplify the situation where the nitrile is at the end of the carbon chain—that is a primary nitrile situation.

Similar trends are expected where the nitrile is a secondary nitrile which is to say the nitrile is located elsewhere than at the end.

Similar trends are expected where the nitrile, either primary or secondary nitrile has a hydrocarbon or other substitutions such as alkyl, benzyl, hydroxide, chlorine, bromine, alkoxy, nitro or other groups commonly bound to hydrocarbon chains on the hydrocarbon chain.

### In Use

Embodiments of the method of the present invention provide a simple way of collecting or recovering metals or mineral compounds. Referring to FIG. 3, one may first wet grind the ore 10 to a desired particle size utilizing grinding or crushing equipment. The ground ore may then be fed into a container such as a flotation cell 14. Usually this flotation cell is agitated. Water chemicals 16 such as frothers or slurry modifiers may then be added to the flotation cell to mix with the ground ore so as to prepare a slurry. An effective proportion of a collector 18 may then be mixed with the slurry. The collector 18 comprises a functional group which has a carbon chain with a nitrile attached. The carbon chain has at least 11 or more carbon atoms. A gas stream may then be injected into the slurry so as to generate a froth on the slurry surface. The gas generated bubbles carry the attached mineral/collector complex into the froth. As a result, the desired metals and mineral sulphides being collected by the collect float to the top of the slurry while the undesired metal sulphides and gangue remain in the slurry. The metals and mineral sulphides then become readily available for recovery preferably via an outlet 20 provided in the proximity of the upper portion of the flotation cell 14.

The above describes only some embodiments of the present invention and modifications, obvious to those skilled in the art, can be made thereto without departing from the scope and spirit of the present invention.

1. A metal or mineral compound collector for use in a froth flotation process so as to recover one or more of precious metal or oxide mineral or sulphide mineral from an ore; the collector comprising a functional group attached to a carbon chain; the functional group being a nitrile and the said chain having 11 or more carbon atoms.

2. The metal or mineral compound collector of claim 1 wherein the collector comprises a mixture of nitrites in which one or more predominating nitrites contain at least 11 carbon atoms.

3. The metal or mineral compound collector of claim 1 wherein the collector comprises a mixture of nitrites in which one or more predominating nitrites contain at least 12 carbon atoms.

4. The metal or mineral compound collector of claim 1 wherein the collector comprises a mixture of nitrites in which one or more predominating nitrites contain at least 13 carbon atoms.

5. The metal or mineral compound collector of claim 1 wherein the collector comprises a mixture of nitrites in which one or more predominating nitrites contain at least 14 carbon atoms.

6. The metal or mineral compound collector of claim 1 wherein the collector comprises a mixture of nitrites in which one or more predominating nitrites contain at least 15 carbon atoms.

7. The metal or mineral compound collector of claim 1 wherein the collector comprises a mixture of nitrites in which one or more predominating nitrites contain at least 16 carbon atoms.

8. The metal or mineral compound collector of claim 1 wherein the collector comprises a mixture of nitrites in which one or more predominating nitrites contain at least 17 carbon atoms.

9. The metal or mineral compound collector of claim 1 wherein the collector comprises a mixture of nitrites in which one or more predominating nitrites contain at least 18 carbon atoms.

10. The metal or mineral compound collector of claim 1 wherein the collector comprises a mixture of nitrites in which one or more predominating nitrites contain between 11 to 20 carbon atoms.

11. The metal or mineral compound collector of claim 1 wherein the collector comprises a mixture of nitrites in which one or more predominating nitrites contain between 12 to 20 carbon atoms.

12. The metal or mineral compound collector of claim 1 wherein the collector comprises a mixture of nitrites in which one or more predominating nitrites contain between 13 to 20 carbon atoms.

13. The metal or mineral compound collector of claim 1 wherein the collector comprises a mixture of nitrites in which one or more predominating nitrites contain between 14 to 20 carbon atoms.

14. The metal or mineral compound collector of claim 1 wherein the collector comprises a mixture of nitrites in which one or more predominating nitrites contain between 15 to 20 carbon atoms.

15. The metal or mineral compound collector of claim 1 wherein the collector comprises a mixture of nitrites in which one or more predominating nitrites contain between 16 to 20 carbon atoms.

16. The metal or mineral compound collector of claim 1 wherein the collector comprises a mixture of nitrites in which one or more predominating nitrites contain between 17 to 20 carbon atoms.

17. The metal or mineral compound collector of claim 1 wherein the collector comprises a mixture of nitrites in which one or more predominating nitrites contain at least 18 to 20 carbon atoms.

18. The metal or mineral compound collector of claim 1 comprising one carbon chain length.

19. The metal or mineral compound collector of claim 1 wherein said collector includes a dodecyl nitrile.

20. The metal or mineral compound collector of claim 1 wherein said collector comprises a mixture of nitrites having different carbon chain lengths.

21. The metal or mineral compound collector of claim 1 including coco nitrile or hydrogenated tallow nitrile.

22. The metal or mineral compound collector of claim 1 wherein the mineral compound includes metallic sulphides.

23. The metal or mineral compound collector of claim 1 wherein the mineral compound comprises metallic sulphides including chalcopyrite, bornite, chalcocite, covellite, galena, sphalerite thereof.

24. The metal or mineral compound collector of claim 1 wherein the metals include gold, silver or platinum group metals.

25. The metal or mineral compound collector of claim 1 wherein said chain is saturated.

26. The mineral or metal metal collector of claim 1 wherein the functional group includes a mixture of two or more nitrites.

27. The metal or mineral compound collector of claim 21 wherein one of the nitrites is a secondary nitrile.

28. The metal or mineral compound collector of claim 1 wherein the collector is mixed with xanthates, dithiophosphates, thionocarbamates, mercaptobenzylthiazoles, monothiophosphates and dithiophosphinates or other sulphide collectors.

29. The metal or mineral compound collector of claim 1 wherein one or more of the carbons in the carbon chain is substitutable.

30. The metal or mineral compound collector of claim 1 wherein the carbon chain is substitutable by other chemical groups including alkyl, benzyl, chlorine, bromine, alkoxy, nitro or nitrile.

31. A method of recovering a precious metal or oxide mineral or sulphide mineral compound from an ore comprising the steps of:
wet grinding the ore to a desired particle size;
adding water chemicals such as frothers or slurry modifiers to the ground ore so as to prepare a slurry;
adding an effective proportion of a collector comprising a functional group which has a carbon chain with a nitrile attached, said chain having 11 or more carbon atoms;
supplying a gas stream to the slurry so as to generate a froth; and
recovering the desired metal, oxide mineral and/or sulphide mineral compound thereof in the froth.

32-60. (canceled)
